(19) United States
(12) Patent Application Publication
(10) Pub. No.: US 2018/0296008 A1
(43) Pub. Date: Oct. 18, 2018

(54) WIG STAND

(71) Applicant: I2M Co., Ltd., Daejeon (KR)

(72) Inventor: Dong Yeon CHO, Daejeon (KR)

(21) Appl. No.: 15/675,917

(22) Filed: Aug. 14, 2017

(30) Foreign Application Priority Data
Apr. 17, 2017 (KR) 10-2017-0049373

(51) Int. Cl. A47F 7/06; A45D 20/44; F21S 6/00

(52) U.S. Cl. CPC A47F 7/065; A45D 44/14; F21S 6/008; A45D 20/44

(57) ABSTRACT

A wig stand comprises a wig stand head including a partitioning wall and a body member connected with the partitioning wall plate and having an hollow space, a photocatalytic material applied to the body member, a supporting base provided under the wig stand head to support the wig stand head, a lighting device provided in the wig stand head to emit light, and a fan provided in the supporting base to circulate air in the wig stand head, wherein the space includes a lower space section and a middle space section continuously extending up from the lower space section, wherein the lighting device is positioned in the middle space section, wherein the body member has a honeycomb shape including a plurality of pieces of nonwoven fabric that are continuously attached together, and wherein the body member includes a plurality of upper inside paths.

### CROSS-REFERENCE TO RELATED APPLICATIONS

This patent application claims priority under 35 U.S.C. § 119 to Korean Patent Application No 10-2017-0049373, filed on Apr. 17, 2017, in the Korean Intellectual Property Office, the disclosure of which is incorporated by reference herein in its entirety.

### TECHNICAL FIELD

The present disclosure relates to a stand for hanging a wig and more specifically to a wig stand structured to enable sterilization and deodorization in a more efficient way.

### DISCUSSION OF RELATED ART

A wig is a head covering made from human hair, animal hair, or synthetic fiber. Wigs are used for various purposes, e.g., to disguise baldness.

A wig worn by a man or woman needs to be properly cared for in order to maintain its natural appearance or keep it clean after washing or during storage.

A few types of wig holders or stands have been known, such as e.g., mannequin wig heads or wire wig stands for storage purposes. However, such conventional hairpiece holders cannot respond to the problems with odors or germ growth when a wig used is placed thereon for storage.

### SUMMARY

According to an embodiment of the present disclosure, a wig stand comprises a wig stand head including a partitioning wall and a body member connected with the partitioning wall plate and having an hollow space, a photocatalytic material applied to the body member, a supporting base provided under the wig stand head to support the wig stand head, a lighting device provided in the wig stand head to emit light, and a fan provided in the supporting base to circulate air in the wig stand head, wherein the space includes a lower space section and a middle space section continuously extending up from the lower space section, wherein the lighting device is positioned in the middle space section, wherein the body member has a honeycomb shape including a plurality of pieces of nonwoven fabric that are continuously attached together, and wherein the body member includes a plurality of upper inside paths positioned adjacent to the lower space section and the middle space section, having a side surface opened to a central portion of the body member, an opened top, and an opened both, formed radially from the central portion of the body member, and allowing air to pass therethrough and a plurality of upper middle paths provided alternately and repetitively with the upper inside paths, having both closed sides, an opened top, and an opened bottom, formed radially from the central portion of the body member, and allowing the air to pass therethrough.

According to an embodiment of the present disclosure, the body member includes an upper body, a middle body extending down from the upper body and forming the middle space section, and a lower body extending down from the middle body and forming the lower space section.

According to an embodiment of the present disclosure, the middle body includes a plurality of middle inside paths having a side opened to the central portion and communicating with the upper middle paths and a plurality of middle outside paths having a side opened to an outside and communicating with the upper outside paths and Wherein the upper body includes upper outside paths provided alternately and repetitively with the upper middle paths, having a side opened to the outside, an opened top, and an opened bottom, and formed radially from central portion.

According to an embodiment of the present disclosure, an upper space section that is hollow extends up from the middle space section, and wherein a diameter of the lower space section is larger than a diameter of the middle space section, and the diameter of the middle space section is larger than a diameter of the upper space section.

According to an embodiment of the present disclosure, the supporting base includes a cylindrical part having a groove into which an end of the wig stand head is fitted and a supporting part for supporting the cylindrical part against an underneath floor, wherein the supporting base includes a ventilation outlet for supplying an air flow generated by the fan provided in the supporting base to the wig stand head, and wherein a socket installation hole is provided at a center of the ventilation outlet to insert a bulb.

According to an embodiment of the present disclosure, the supporting base includes a ring-shaped auxiliary support under the supporting part, the auxiliary support having a plurality of protrusions spaced apart from each other at predetermined intervals.

According to an embodiment of the present disclosure, the wig stand further comprises a scalp massager connected with the lighting device, wherein the scalp massager includes a vibrator connected with a multi-port device installed in the lighting device and a scalp massaging member having a plurality of sawtooth-shaped protrusions that are vibrated by the vibrator to massage a scalp.

According to an embodiment of the present disclosure, the wig stand further comprises a camera in a center of the scalp massager to capture an image of the scalp.

According to an embodiment of the present disclosure, the nonwoven fabric has a lower portion and an upper portion broader than the lower portion.

### BRIEF DESCRIPTION OF THE DRAWINGS

A more complete appreciation of the present disclosure and man of the attendant aspects thereof will be readily obtained as the same becomes better understood by reference to the following detailed description when considered in connection with the accompanying drawings, wherein:

FIG. 1 is a perspective view illustrating a wig stand according to an embodiment of the present disclosure;

FIG. 2 is an exploded perspective view illustrating a wig stand according to an embodiment of the present disclosure;

FIG. 3 is an exploded cross-sectional view illustrating a wig stand according to an embodiment of the present disclosure;

FIG. 4 is a cross-sectional view illustrating a wig stand assembled, according to an embodiment of the present disclosure;

FIG. 5 illustrates a scalp massager of a wig stand and an example of using the scalp massager, according to an embodiment of the present disclosure;

FIG. 6 is a view illustrating a wig stand including a scalp massager and on which a wig is placed, according to an embodiment of the present disclosure;

FIG. 7 is a perspective view illustrating a body member of a wig stand according to an embodiment of the present disclosure; and

FIG. 8 is a cross-sectional view illustrating a body member 113 of a wig stand according to an embodiment of the present disclosure.

### DETAILED DESCRIPTION OF EXEMPLARY EMBODIMENTS

Hereinafter, exemplary embodiments of the present disclosure will be described in detail with reference to the accompanying drawings. The same reference denotations may be used to refer to the same or similar elements throughout the specification and the drawings. The present disclosure, however, may be modified in various different ways, and should not be construed as limited to the embodiments set forth herein. It will be understood that when an element or layer is referred to as being “on,” “connected to,” “coupled to,” or “adjacent to” another element or layer, it can be directly on, connected, coupled, or adjacent to the other element or layer, or intervening elements or layers may be present. As used herein, the singular forms “a,” “an,” and “the” are intended to include the plural forms as well, unless the context clearly indicates otherwise.

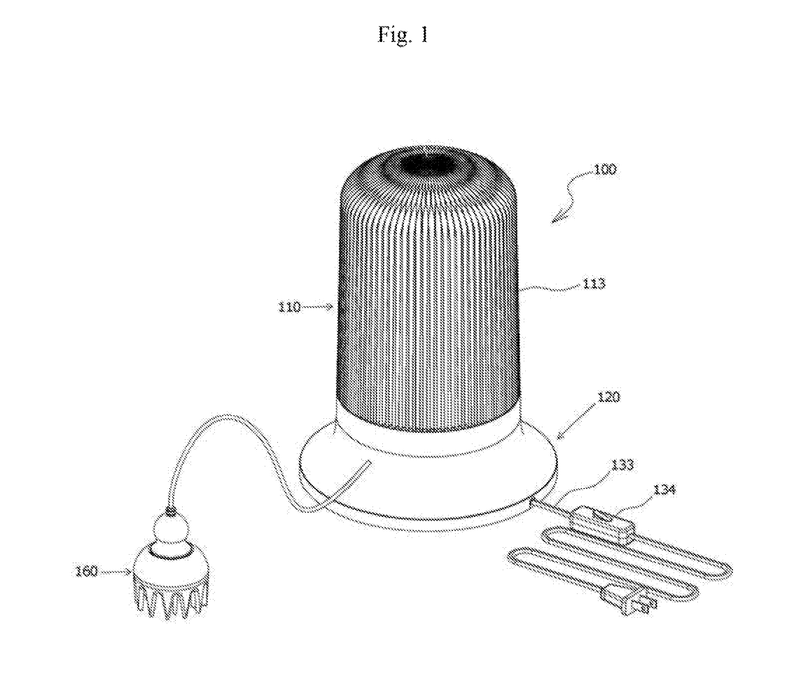

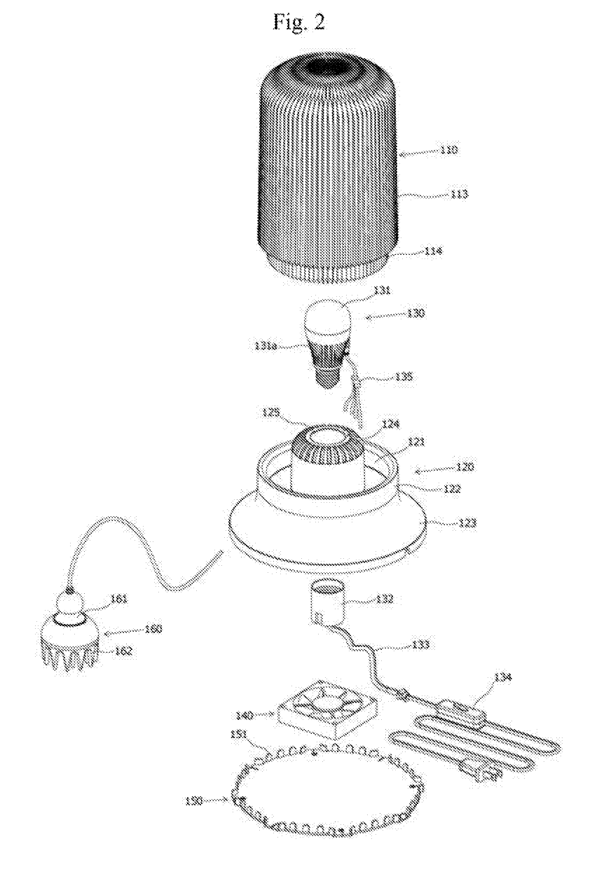

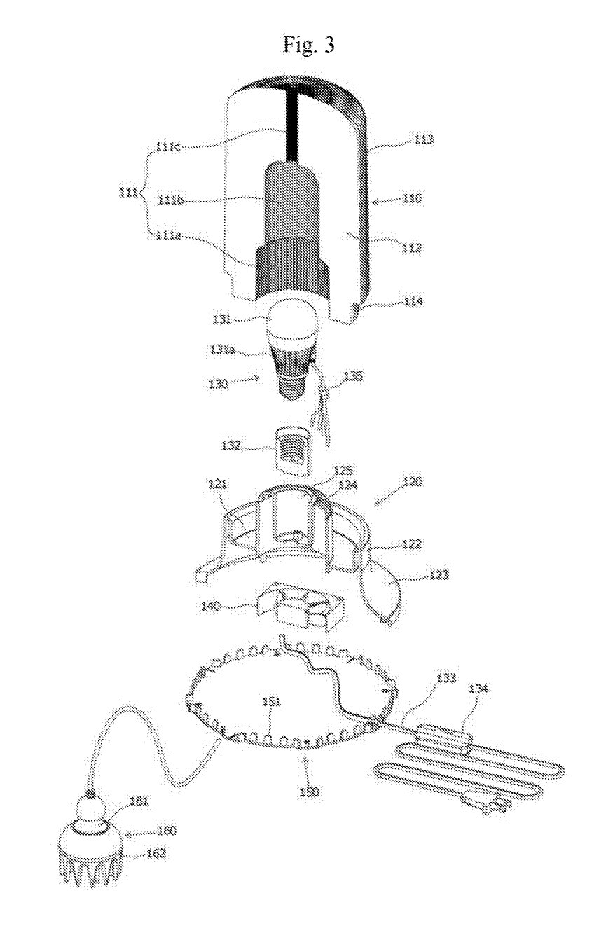

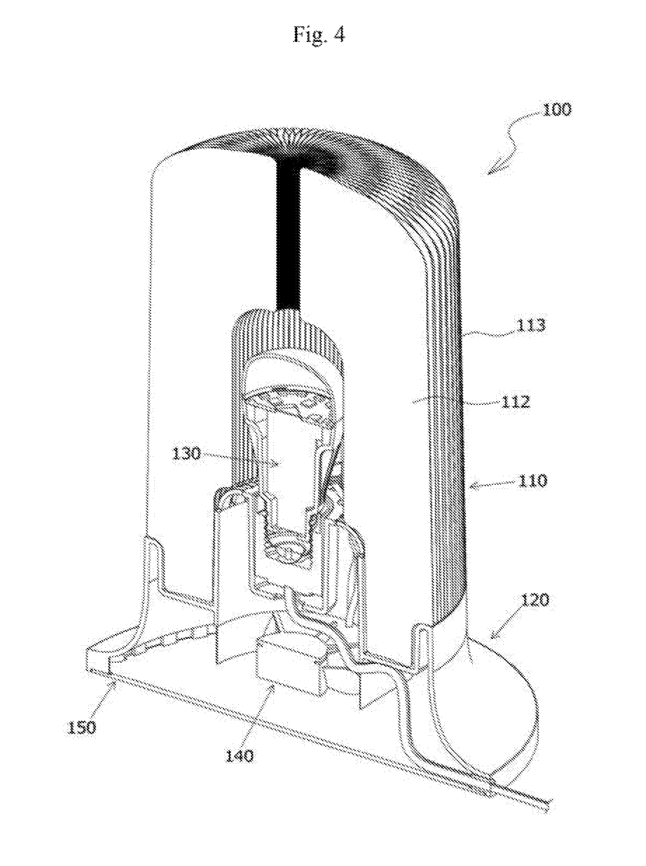

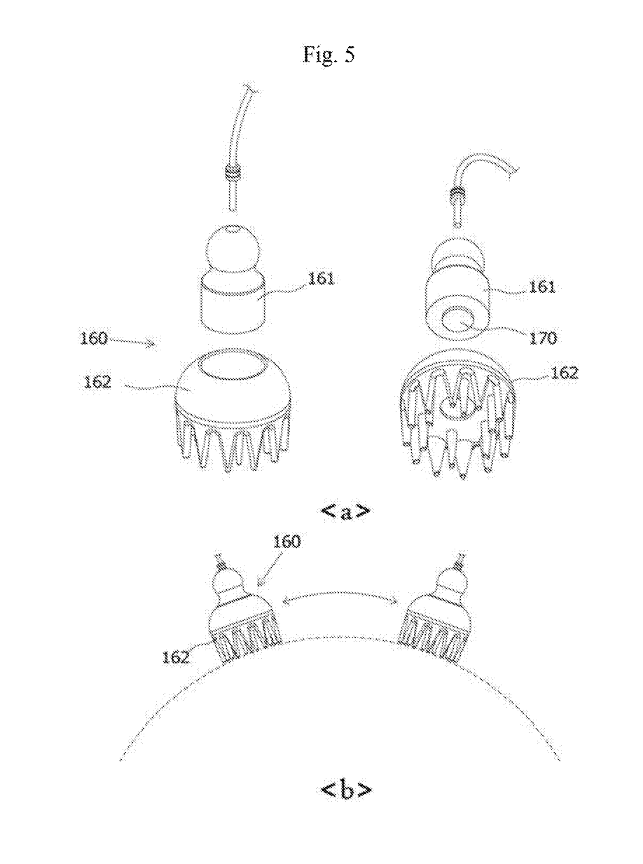

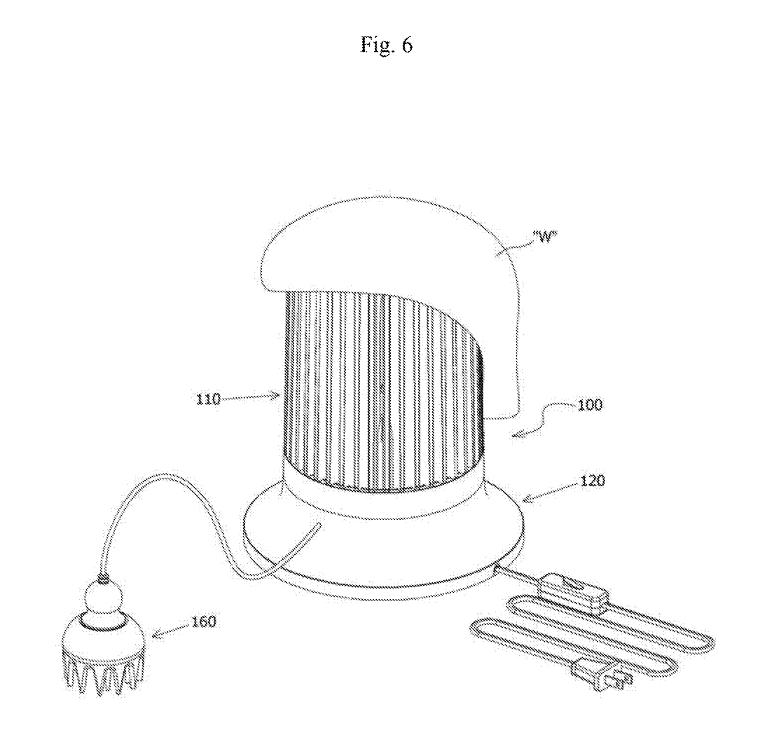

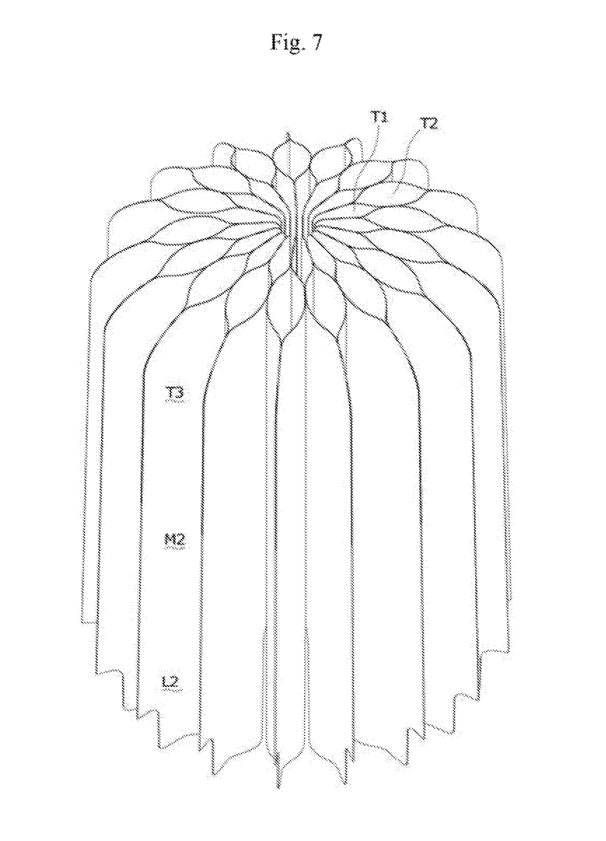

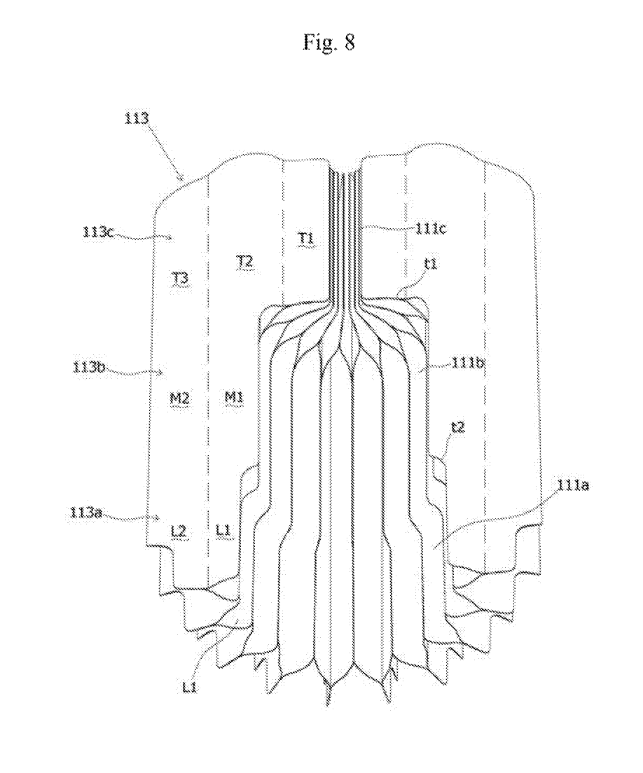

FIG. 1 is a perspective view illustrating a wig stand according to an embodiment of the present disclosure. FIG. 2 is an exploded, perspective view illustrating a wig stand according to an embodiment of the present disclosure. FIG. 3 is an exploded cross-sectional view illustrating a wig stand according to an embodiment of the present disclosure. FIG. 4 is a cross-sectional view illustrating a wig stand assembled, according to an embodiment of the present disclosure. FIG. 5 illustrates a scalp massager of a wig stand and an example of using the scalp massager, according to an embodiment of the present disclosure. FIG. 6 is a view illustrating a wig stand including a scalp massager and on which a wig is placed, according to an embodiment of the present disclosure. FIG. 7 is a perspective view illustrating a body member of a wig stand according to an embodiment of the present disclosure. FIG. 8 is a cross-sectional view illustrating a body member 113 of a wig stand according to an embodiment of the present disclosure.

According to an embodiment of the present disclosure, 1. A wig stand 100, comprising:

a wig stand head 110 including a partitioning wall 112 and a body member 113 connected with the partitioning wall plate 112 and having an hollow space 111, a photocatalytic material applied to the body member 113;

a supporting base 120 provided under the wig stand head 110 to support the wig stand head 110;

a lighting device 130 provided in the wig stand head 110 to emit light; and

a fan 140 provided in the supporting base 120 to circulate air in the wig stand head 110, wherein the space 111 includes a lower space section 111a and a middle space section 111b continuously extending up from the lower space section 111a, wherein the lighting device 130 is positioned in the middle space section 111b, wherein the body member 113 has a honeycomb shape including a plurality of pieces of nonwoven fabric that are continuously attached together, and wherein the body member 113 includes a plurality of upper inside paths T1 positioned adjacent to the lower space section 111a and the middle space section 111b, having a side surface opened to a central portion of the body member 113, an opened top, and an opened both, formed radially from the central portion of the body member 113, and allowing air to pass therethrough and a plurality of upper middle paths 12 provided alternately and repetitively with the upper inside paths T1, having both closed sides, an opened top, and an opened bottom, formed radially from the central portion of the body member 113, and allowing the air to pass therethrough.

According to an embodiment of the present disclosure, the body member 113 includes an upper body 113c, a middle body 113b extending down from the upper body 113c and forming the middle space section 111b, and a lower body 113a extending down from the middle body 113b and forming the lower space section 111a.

According to an embodiment of the present disclosure, the middle body 113b includes a plurality of middle inside paths M1 having a side opened to the central portion and communicating with the upper middle paths T2 and a plurality of middle outside paths M2 having a side opened to an outside and communicating with the upper outside paths T3 and wherein the upper body 113c includes upper outside paths T3 provided alternately and repetitively with the upper middle paths T2, having a side opened to the outside, an opened top, and an opened bottom, and formed radially from the central portion.

According to an embodiment of the present disclosure, the wig stand 100 of claim 1, wherein an upper space section 111c that is hollow extends up from the middle space section 111b, and wherein a diameter of the lower space section 111a is larger than a diameter of the middle space section 111b, and the diameter of the middle space section 111b is larger than a diameter of the upper space section 111c.

According to an embodiment of the present disclosure, the supporting base 120 includes a cylindrical part 122 having a groove 121 into which an end of the wig stand head 110 is fitted and a supporting part 123 for supporting the cylindrical part 122 against an underneath floor, wherein the supporting base 120 includes a ventilation outlet 124 for supplying an air now generated by the fan 140 provided in the supporting base 120 to the wig stand head 110, and wherein a socket installation hole 125 is provided at a center of the ventilation outlet 124 to insert a bulb.

According to an embodiment of the present disclosure, the supporting base 120 includes a ring-shaped auxiliary support 150 under the supporting part 123, the auxiliary support 150 having a plurality of protrusions spaced apart from each other at predetermined intervals.

According to an embodiment of the present disclosure, the wig stand 100 further comprises a scalp massager 160 connected with the lighting device 130, wherein the scalp massager 160 includes a vibrator 161 connected with a multi-port device 135 installed in the lighting device 130 and a scalp massaging member 162 having a plurality of sawtooth-shaped protrusions that are vibrated by the vibrator 161 to massage a scalp.

According to an embodiment of the present disclosure, the wig stand further comprises a camera 170 in a center of the scalp massager 160 to capture an image of the scalp.

According to an embodiment of the present disclosure, the nonwoven fabric has a lower portion and an upper portion broader than the lower portion.

Referring to FIGS. 1 to 6, according to an embodiment of the present disclosure, a wig stand 100 capable of sanitization and deodorization using photocatalysis includes a wig stand head 110, a supporting base 120, a lighting device 130, and a fan 140.

The wig stand head 110 may include one or more partitioning will plates 112 and a body member 113. A wig may be placed over the partitioning wall plates 112. The body member 113 may be connected with the partitioning wall plates 112. The body member 113 may have a space in a middle portion thereof. The body member 113 may be shaped as an accordion or a honeycomb. A photocatalytic material may be applied to the body member 113.

The supporting base 120 may be installed at a lower end of the wig stand head 110 to support the wig stand head 110.

The lighting device 130 may be provided inside the wig stand head 110 to radiate light.

The fan 140 may be installed in the supporting base 120 to forcedly draw air in from the outside and discharge the air through the inside of the wig stand head 110 to the top, circulating (or ventilating) air between the inside and outside.

Referring to FIG. 3, the wig stand head 110 includes a protrusion 114 in the bottom to facilitate to detachably fit into a groove 121 formed in the supporting base 120.

Although the wig stand head 110 is shown to have a cylindrical shape with the space 111 formed therein for easier hanging a wig thereover, the shape of the wig stand head 110 is not limited thereto. For example, the wig stand head 110 may have various shapes depending on installation environments.

The space 111 formed inside the wig stand head 110 includes a lower space section 111a in which a ventilation outlet 124 of the fan 140 is inserted, a middle space section 111b that extends upwards from the lower space section 111a and in which a bulb 131 of the lighting device 130 is inserted, and an upper space section 111c that extends upwards from the middle space section 111b to enable easier transmission of external air into the inside.

The diameter of the lower space section 111a may be larger than the diameter of the middle space section 111b, and the diameter of the middle space section 111b may be larger than the upper space section 111c. However, the relationship in diameter between the lower space section 111a, the middle space section 111b, and the upper space section 111c is not limited thereto. For example, the middle space section 111b may be the same in diameter as the upper space section 111c, or the middle space section 111b may extend up to the top.

The photocatalytic material-applied body member 113 may be formed of a nonwoven fabric. The body member 113 may have a honeycomb shape that includes a plurality of pieces of nonwoven fabric that are attached together as shown and that includes long straw-shaped air paths in an upper or lower direction as shown in FIGS. 7 and 8. At a side view, one of the pieces of nonwoven fabric is configured so that its upper portion is broader while its lower portion is narrower and the piece of nonwoven fabric has a first step t1 where the upper space section 111c connects to the middle space section 111b and a second step t2 where the middle space section 111b connects to the lower space section 111a. As the upper portion of the piece of nonwoven fabric widens, the upper space section 111c may shrink.

The body member 113 may be formed in the honeycomb shape by continuously attaching several pieces of nonwoven fabric. The body member 113 may be divided into an upper body 113c where the upper space section 111c is formed, a middle body 113b where the middle space section 111b is formed, and a lower body 113a where the lower space section 111a is formed.

The long straw-shaped air paths include upper paths that include upper inside paths T1, upper middle paths T2, and upper outside paths T3. The upper inside paths T1 are continuously formed along a circumferential direction of the space, radially surrounding the space and allowing air to pass therethrough. Each of the upper inside paths T1 has an opened top surface, an opened bottom surface, and a side surface that is positioned adjacent to a central portion formed inside the space and that is opened towards the central portion. The upper middle paths T2 are formed along the circumferential direction continuously and alternately and repetitively with the upper inside paths T1, allowing air to pass therethrough. Each of the upper middle paths T2 has four closed surfaces, an opened top surface, and an opened bottom surface. The upper outside paths T3 are formed along the circumferential direction continuously and alternately and repetitively with the upper middle paths T2, allowing air to pass therethrough. Each of the upper outside paths T3 has a side surface opened to the outside, an opened top surface, and an opened bottom surface. Each upper path T1, T2, or T3 is shaped as a straw that is elongated in an upper or lower direction, allowing air blown from the fan 140 to pass is therethrough. Although three upper paths T1, T2, and T3 are shown for illustration purposes, more or fewer upper paths may be provided depending on their diameter or the size of the wig stand.

Multiple middle inside paths M1 may be provided under the upper paths T1, T2, and T3 to communicate with the upper middle paths T2. Multiple middle outside paths M2 may be provided under the upper paths T1, T2, and T3 to communicate with the upper outside paths T3. Each of the middle inside paths M1 has a side surface opened to the central portion, and each of the middle outside paths M2 has a side surface opened to the outside.

Multiple lower inside paths L1 may be provided under the middle paths M1 and M2 to communicate with the middle inside paths M1. Multiple lower outside paths L2 may be provided under the middle outside paths M1 and M2 to communicate with the middle outside paths M2. Each of the lower inside paths L1 has a side surface opened to the central portion, and each of the lower outside paths L2 has a side surface opened to the outside.

The upper outside path T3, the middle outside path m2, and the lower outside path L2 together may form a single outside path to function as a path through which external air pulled up into a wig when the wig is placed on the body member 113 is drawn back down.

The upper middle path T2, the middle inside path M1, and the lower inside path L1 together may also form a single whole path.

The upper paths T1, T2, and T3 include the upper inside path T1, the upper middle path T2, and the upper outside path T3, the middle paths M1 and M2 include the middle inside path M1 and the middle outside path M2, and the lower paths L1 and L2 include the lower inside path L1 and the lower outside path L2.

The upper paths, the middle paths, and the lower paths each are shaped as an empty straw from the top to the bottom. Even when each upper path is connected to its corresponding middle path, or the middle path is connected to its corresponding lower path, the upper path, the middle path, and the lower path together may form a whole empty path through which air may pass. The upper paths, the middle paths, and the lower paths are named so according to their position along the vertical direction of the wig stand 100, and they may also be named upper paths and lower paths only.

The upper path, middle path, and lower path may be formed in a vertical direction from the bottom to the top, but without limited thereto, they may also be formed to be inclined in Which case the path through which air passes may have different diameters at its top and bottom. For example, where the upper path, middle path, and lower path are inclined to spread from the bottom to the top, the diameter of the lower path may be smaller than the diameter of the upper path.

Although the upper body 113c, the middle body 113b, and the lower body 113a have groups each including three air flow paths radially formed from the central portion to the outside, the number of air flow paths may be varied, e.g., more or fewer air flow paths may be provided. In such case, the paths closest to the central portion may have sides opened to the central portion, opened tops, opened bottoms, and closed outer sides formed alternately and furthest from the central portion, so that air from the fan 140 may contact a broad area of the photocatalytic material applied to the nonwoven fabric while passing through the inside of the nonwoven fabric and be then provided through the upper paths to the wig.

A more detailed description is given below.

When the fan 140 operates, external air is pulled up to the ventilation outlet 124 in the lower space section 111a.

The air introduced from the fan 140—e.g., when air is pushed up by the rotation of the fan 140)—passes through the middle space section 111b and is pushed through the paths between the pieces of nonwoven fabric up the body member 113 up to the top of the body member 113, contacting the wig.

In other words, external air introduced through the ventilation outlet 124 ascends through the middle inside path M1 and the upper middle path T2 as well as the upper inside path T1.

The external air passed up through the middle inside path M1, the upper middle path T2, and the upper inside path T1 goes beyond the top of the body member 113, contacting the wig W.

After contacting the wig W, the external air is descended through the upper outside path T3, the middle outside path M2, and the lower outside path L2 while partially contacting a side portion of the inside of the wig W and partially being spread to the outside.

As described above, the photocatalytic material is applied to the body member 113. Thus, when the air is pushed up through the middle inside path M1, the upper middle path T2, and the upper inside path T1 by the fan 140 or when the external air goes down through the upper outside path T3, the middle outside path M2, and the lower outside path L2, the photocatalytic material is activated.

Since the air pushed in by the fan 140 travels up through the paths, the air may contact a broad area of the photocatalytic material, maximizing photocatalytic effects.

The air pushed up while contacting the photocatalytic material may intensively contact the inner surface of the wig (e.g., the portion of the inside of the wig which contacts the top of the user's head) which may be highly contaminated. When a wig remains placed on the body member 113, the air then descends through the paths in the outermost side of the body member 113 while continuing to contact the inside of the wig, and when there is no wig placed on the body member 113, the air may be purified by contacting the photocatalytic material, and the purified air goes up and spreads out.

When there is no wig placed on the body member 113, the fan 140 may turn in an opposite direction, purifying the air around the wig stand.

The supporting base 120 includes a cylindrical part 122 having a groove 121 into which the protrusion 114 of the wig stand head 110 is fitted and a supporting part 123 that is provided under the cylindrical part 122 to securely support the wig stand on its underneath floor. The cylindrical part 122 widens away from the cylindrical part 122.

Air passing through the nonwoven fabric piece (i.e., the protrusion 114) of the body member 113 which is placed in the groove 121 of the supporting base 120 is prevented from flowing down the nonwoven fabric by the walls of the groove 121, the supporting part 123, and the ventilation outlet 124.

The ventilation outlet 124 is provided at the center of the supporting base 120 to supply an air flow generated by the fan 140 to the space 111. A socket installation hole 125 is provided in the center of the ventilation outlet 124 to allow a socket 132 to be inserted thereinto. A bulb 131 is fitted, into the socket 132.

Depending on the direction in which the fan 140 rotates around the socket installation hole 125, external air may be drawn into the space 111 or internal air may be discharged from the space 111 through the ventilation outlet 124 to the outside.

The ventilation outlet 124 is provided around the socket installation hole 125, preventing the lighting device 130 including the bulb 131 installed in the socket installation hole 125 from overheating. In other words, an air flow generated as the fan 140 rotates continues around the bulb 131, lowering the temperature of the bulb (e.g., a light emitting diode (LED) lamp) and purifying air.

A power line 133 and a switch 134 connect an external power source with the socket 132 through the supporting base 120 to supply power to the bulb 131.

A multi-port device 135 may be provided in or at a bulb housing 131a. The multi-port device 135 may include multiple power output ports. The bulb globe of the bulb 131 may be installed in the bulb housing 131a. The bulb housing 131a may include a wireless communication module to enable remote switch-on/off from the outside.

The multi-port device 135 for external connections may be provided at a side of the bulb housing 131a to provide various types of power used in the wig stand. For example, power may be supplied to the fan 140, an air quality sensor, a scalp massager 160, and a camera 170 through the multi-port device 135.

The body member 113 may be installed on the partitioning wall plates 112 along a circumferential direction to form a cylindrical shape, with the space 111 formed therein.

In other words, the body member 113 is attached to the partitioning wall plates 112 to form a balanced shape as viewed from outside, with the space 111 formed therein. The lighting device 130 is positioned in the middle space section 111b of the space 111.

The ventilation outlet 124 may be positioned in the lower space section 111a of the space 111.

According to embodiments of the present disclosure, one or more partitioning wall plates 112 may be provided to support the body member 113. The body member 113 may be coupled, connected, or attached to the partitioning wall plate 112 by various methods, e.g., using an adhesive or screws or others.

A photocatalytic material which is activated by light may be applied to the body member 113.

A ring-shaped auxiliary support 150 may be provided under the supporting part 123 of the supporting base 120. The auxiliary support 150 may include a plurality of protrusions 151 that are spaced apart from each other at predetermined intervals to allow external air to freely enter or exit the inside of the supporting base 120.

Thus, as the fan 140 is driven, external air may easily be supplied to the body member 113 through the spaces between the protrusions 151 of the auxiliary support 150 which is provided on the bottom of the supporting part 123.

For example, external air may be drawn in the inside of the supporting base 120 through the spaces between the protrusions 151 as the fan 140 operates and is then moved via the ventilation outlet 124 and the space 111 of the body member 113, then discharged out. As such, air ventilation may be easily achieved.

When the body member 113 is formed of an air-permeable material, external air drawn in may partly spread through the wall of the body member 113 to the outside, leading to better air refreshing effects. Further, according to an embodiment of the present disclosure, the wig stand functions to purify ambient air. When no wig is on the body member 113, the photocatalytic material applied to the body member 113 may be activated by the lighting device 130 when external air introduced by the fan 140 passes through the space 111, thereby purifying the air.

An air quality sensor (not shown) may be provided inside the wig stand head 110 to measure the contamination of external air. The air quality sensor may grasp the degree of air contamination of the wig stand and automatically or manually control the driving of the fan 140. Thus, the absent of a wig on the wig stand or the contamination of a wig placed on the wig stand head 110 may actively be checked, leading to removal of contaminants in an efficient way.

After a wig is placed over the wig stand head 110, when various organic materials (e.g., volatile organic compounds (VoCs)) coming from the wig or in the air are detected by the air quality sensor installed inside the wig stand, the fan 140 may be driven to effectively remove the organic materials. In such case, the lighting device 130 may be operated to activate the photocatalytic material, removing both odors and germs.

A scalp massager 160 may be connected to the lighting device 130. The scalp massager 160 may detachably be provided to the supporting base 120.

The scalp massager 160 may include a vibrator 161 connected to the multi-port device 135 installed at the bulb housing 131a and a scalp massaging member 162 that has sawtooth-shaped protrusions and that is vibrated by the vibrator 161 to massage the user's scalp.

When the vibrator 161 is driven with the scalp massaging member 162 placed on the user's scalp, the sawtooth-shaped protrusions of the scalp massaging member 162 are vibrated by the vibrator 161 to massage the user's scalp, keeping his/her scalp healthy.

A camera 170 may be provided at the center inside the scalp massager 160 to take an image of the scalp. The user may check the condition of his/her scalp by the image.

A wig wearer typically checks the condition of his/her scalp by looking to an image reflected on a mirror or an image captured by a mobile phone, e.g., a cellular phone.

However such way fails to present reliable results in observing the user's scalp condition because the distance between the scalp and the mobile phone may be varied whenever image capturing is performed.

According to the present disclosure, the camera 170 may be fastened to an upper portion of the scalp massaging member 162. Thus, when the scalp massaging member 162 is moved along the scalp to massage as shown in FIG. 5(b), the camera 170 may capture images of the scalp with the distance remaining same, providing better and more reliable results. The images captured by the camera 170 may be stored in a memory (not shown) provided in the lighting device 130 and may be checked as necessary. The images, information, or other data stored in the memory may be extracted through the multi-port device 135.

Light emitted from the lighting device 130 may be directed only in an upper vertical direction of the wig stand 100. Thus, the wig stand 100, although placed near the bed, may serve as a mood lamp without interrupting sleep.

The body member 113 may provide a space for transmission of air or light in its side. Thus, light may be transmitted through the body member 113 to the outside, promoting activation of the photocatalytic material.

Referring to FIG. 6, after a wig W is placed over the wig stand head 110, whet the bulb 131 of the lighting device 130 is lighted on, light is transmitted through the body member 113 to the inside of the wig W.

In this case, the photocatalytic material applied to the body member 113 is activated, causing a catalytic reaction.

For example, the photocatalytic material may include titanium dioxide (TiO₂). When light is radiated to the photocatalytic material, e.g., TiO₂, positive holes escaped from the crystal surface of the photocatalytic material react with water molecules, forming hydroxy radicals with very high oxidizing power. The radicals may be used to oxidize organic substances. A light emission may promote such reaction. This course of reaction may be called photocatalysis.

According to the present disclosure, the photocatalytic material applied to the body member 113 may be activated by light from the bulb of the lighting device 130, killing germs or viruses in the wig or deodorizing the wig. Thus, the wig may be kept clean and sanitary.

The fan 140 enables easier and simpler air circulation, keeping the wig more sanitary.

According to the embodiments of the present disclosure, the wig stand enables sterilization or deodorization of a wig placed thereon using photocatalytic effects. For example, a light emission from the lighting device may activate the photocatalytic material applied to the wig stand head, and a ventilating means, e.g., the fan 140, may circulate or ventilate air inside of the wig stand head, killing germs or removing odors from the wig after use. Thus, the wig may be kept clean and sanitary.

The wig stand head is formed of, e.g., nonwoven fabric that is air permeable, allowing for easier air transmission between the inside and the outside and quick drying of the wet wig.

The hollow space is funned inside the wig stand head, and contaminated air around the wig after use may be drawn into the space and may then be purified while passing through the space in contact with the photocatalytic material.

An intensive air flow may be obtained by the low-capacity fan that produces minimized fan noise, allowing for sterilization and deodorization of the wig.

The inside of the wig, particularly a portion subjected to a contact with the top of the user's head, may intensively be deodorized or sterilized by the distinct structure of the wig stand.

The wig stand may include a detachable scalp massager. The user may use the scalp massager to massage his/her scalp, keeping scalp healthy, without a separate massaging tool.

The camera installed in the scalp massager may capture images of the user's scalp at an even height from the scalp even when the user moves the scalp massager along the scalp, enabling efficient check or management of the scalp.

The wig stand may effectively sterilize, deodorize, dry, or manage the wig while the wig is not in use.

The wig stand may also serve as a mood light while achieving sterilization and deodorization.

While the present disclosure has been shown and described with reference to exemplary embodiments thereof, it will be apparent to those of ordinary skill in the art that various changes in form and detail may be made thereto without departing from the spirit and scope of the present disclosure as defined by the following claims.

What is claimed is:

1. A wig stand, comprising:
a wig stand head including a partitioning wall and a body member connected with the partitioning wall plate and having an hollow space, a photocatalytic material applied to the body member;
a supporting base provided under the wig stand head to support the wig stand head;
a lighting device provided in the wig stand head to emit light; and
a fan provided in the supporting base to circulate air in the wig stand head, wherein the space includes a lower space section and a middle space section continuously extending up from the lower space section, wherein the lighting device is positioned in the middle space section, wherein the body member has a honeycomb shape including a plurality of pieces of nonwoven fabric that are continuously attached together, and wherein the body member includes a plurality of upper inside paths positioned adjacent to the lower space section and the middle space section, having a side surface opened to a central portion of the body member, an opened top, and an opened both, formed radially from the central portion of the body member, and allowing air to pass therethrough and a plurality of upper middle paths provided alternately and repetitively with the upper inside paths, having both closed sides, an opened top, and an opened bottom, formed radially from the central portion of the body member, and allowing the air to pass therethrough.

2. The wig stand of claim 1, wherein the body member includes an upper body, a middle body extending down from the upper body and forming the middle space section, and a lower body extending down from the middle body and forming the lower space section.

3. The wig stand of claim 2, wherein the middle body includes a plurality of middle inside paths having a side opened to the central portion and communicating with the upper middle paths and a plurality of middle outside paths having a side opened to an outside and communicating with the upper outside paths and wherein the upper body includes upper outside paths provided alternately and repetitively with the upper middle paths, having a side opened to the outside, an opened top, and an opened bottom, and formed radially from the central portion.

4. The wig stand of claim 1, wherein an upper space section that is hollow extends up from the middle space section, and wherein a diameter of the lower space section is larger than a diameter of the middle space section, and the diameter of the middle space section is larger than a diameter of the upper space section.

5. The wig stand of claim 1, wherein the supporting base includes a cylindrical part having a groove into which an end of the wig stand head is fitted and a supporting part for supporting the cylindrical part against an underneath floor, wherein the supporting base includes a ventilation outlet for supplying an air flow generated by the fan provided in the supporting base to the wig stand head, and wherein a socket installation hole is provided at a center of the ventilation outlet to insert a bulb.

6. The wig stand of claim 5, wherein the supporting base includes a ring-shaped auxiliary support under the supporting part, the auxiliary support having a plurality of protrusions spaced apart from each other at predetermined intervals.

7. The wig stand of claim 1, further comprising a scalp massager connected with the lighting device, wherein the scalp massager includes a vibrator connected with a multi-port device installed in the lighting device and a scalp massaging member having a plurality of sawtooth-shaped protrusions that are vibrated by the vibrator to massage a scalp.

8. The wig stand of claim 7, further comprising a camera in a center of the scalp massager to capture an image of the scalp.

9. The win stand of claim 2, wherein the nonwoven fabric has a lower portion and upper portion broader than the lower portion.
